(19) United States
(12) Patent Application Publication
(10) Pub. No.: US 2025/0023224 A1
(43) Pub. Date: Jan. 16, 2025

(54) ELECTRONIC DEVICE AND ANTENNA MODULE

(71) Applicant: WISTRON NEWEB CORPORATION, HSINCHU (TW)

(72) Inventors: PAO-CHUAN PENG, HSINCHU (TW); TZU-KUAN SUN, HSINCHU (TW); MENG-KAI WU, HSINCHU (TW)

(21) Appl. No.: 18/642,984

(22) Filed: Apr. 23, 2024

(30) Foreign Application Priority Data
Jul. 14, 2023 (TW) 112126322

(51) Int. Cl. H01Q 1/22; H01Q 1/50; H01Q 9/42

(52) U.S. Cl. CPC H01Q 1/2266; H01Q 1/50; H01Q 9/42

(57) ABSTRACT

An electronic device includes a housing, an antenna module, and a feeding element. The antenna module includes a first radiating element and a second radiating element. The first radiating element includes a first arm and a second arm. The second radiating element includes a first radiating portion and a feeding portion. The first radiating portion includes a first section, a second section and a third section. The feeding portion is connected to the first section, the first section includes a first branch and a second branch, and the second section is connected between the first branch and the third section. The first branch, the second section, and the third section jointly form a hook-shaped structure. The first radiating element is disposed on a periphery of the second radiating element. The hook-shaped structure is farther away from the first arm than the second branch.

### CROSS-REFERENCE TO RELATED PATENT APPLICATION

This application claims the benefit of priority to Taiwan Patent Application No. 112126322, filed on Jul. 14, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an electronic device and an antenna module, and more particularly to an antenna module capable of covering multiple frequency bands and an electronic device having the antenna module.

### BACKGROUND OF THE DISCLOSURE

Currently, exterior designs of electronic devices, such as a laptop computer or a tablet computer, are developed toward being thinner and more lightweight, and screen frames of the electronic devices are also gradually becoming narrower. Therefore, an internal space of the electronic device that is available for placement of an antenna is very limited. Moreover, due to the requirement of having a narrow screen frame on the electronic device, an issue of decreased or insufficient bandwidth is likely to occur in the antenna.

Therefore, how to design an antenna structure capable of simultaneously transmitting and receiving multiple wireless frequency bands and having good antenna efficiency within the limited internal space of the electronic device has become an important issue to be addressed in the related art.

### SUMMARY OF THE DISCLOSURE

In response to the above-referenced technical inadequacy, the present disclosure provides an electronic device and an antenna module.

In order to solve the above-mentioned problems, one of the technical aspects adopted by the present disclosure is to provide an electronic device, which includes a housing, an antenna module, and a feeding element. The antenna module is disposed in the housing. The antenna module includes a first radiating element and a second radiating element. The first radiating element includes a first arm and a second arm that is connected to the first arm. The second radiating element includes a first radiating portion and a feeding portion. The first radiating portion includes a first section, a second section, and a third section. The feeding portion is connected to the first section. The first section includes a first branch and a second branch. The second section is connected between the first branch and the third section. The first branch, the second section, and the third section jointly form a hook-shaped structure. The first radiating element is disposed on a periphery of the second radiating element. The hook-shaped structure is farther away from the first arm than the second branch. The feeding element is electrically connected to the feeding portion.

In order to solve the above-mentioned problems, another one of the technical aspects adopted by the present disclosure is to provide an antenna module, which includes a first radiating element and a second radiating element. The first radiating element includes a first arm and a second arm that is connected to the first arm. The second radiating element includes a first radiating portion and a feeding portion. The first radiating portion includes a first section, a second section, and a third section. The feeding portion is connected to the first section and is electrically connected to a feeding element. The first section includes a first branch and a second branch. The second section is connected between the first branch and the third section. The first branch, the second section, and the third section jointly form a hook-shaped structure. The first radiating element is disposed on a periphery of the second radiating element. The hook-shaped structure is farther away from the first arm than the second branch. The feeding element is electrically connected to the feeding portion.

Therefore, in the electronic device and the antenna module provided by the present disclosure, by virtue of “the first branch, the second section, and the third section jointly forming a hook-shaped structure, the first radiating element being disposed on a periphery of the second radiating element, and the hook-shaped structure being farther away from the first arm than the second branch,” the characteristics of the antenna can be optimized to meet more stringent antenna specifications.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of an electronic device according to the present disclosure;

FIG. 2 is a schematic view of an antenna module according to a first embodiment of the present disclosure; and

FIG. 3 is a schematic view of an antenna module according to a second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

In addition, the term “connect” or “connected” in the context of the present disclosure means that there is a physical connection between two elements, and the two elements are directly or indirectly connected. The term “couple” or “coupled” in the context of the present disclosure means that two elements are separate from each other and have no physical connection therebetween, and an electric field energy generated by one of the two elements excites an electric field energy generated by another one of the two elements.

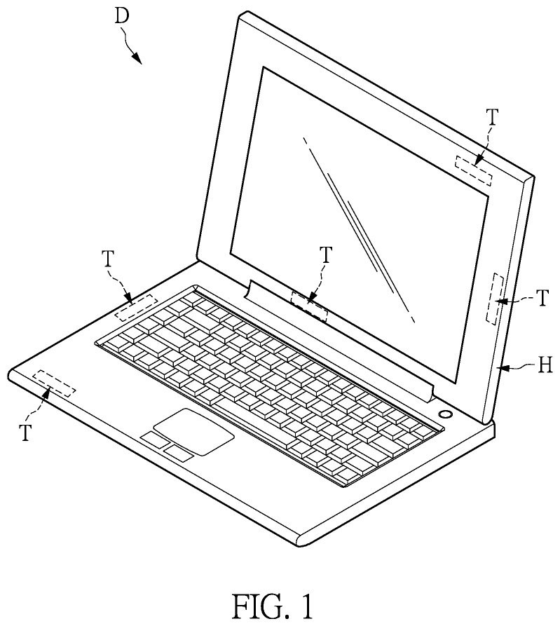

Referring to FIG. 1, FIG. 1 is a schematic perspective view of an electronic device according to the present disclosure. The present disclosure provides an electronic device D, and the electronic device D can be a smart phone, a tablet computer, or a laptop computer. However, the present disclosure is not limited thereto. In the present disclosure, the electronic device D is exemplified as the laptop computer. The electronic device D includes an antenna module T and a housing H, and the antenna module T is disposed in the housing H. The electronic device D can generate at least one operating frequency band through the antenna module T. For example, the antenna module T is disposed at a position of a screen frame of the electronic device D, but the position and quantity of the antenna module T in the electronic device D are not limited in the present disclosure.

### First Embodiment

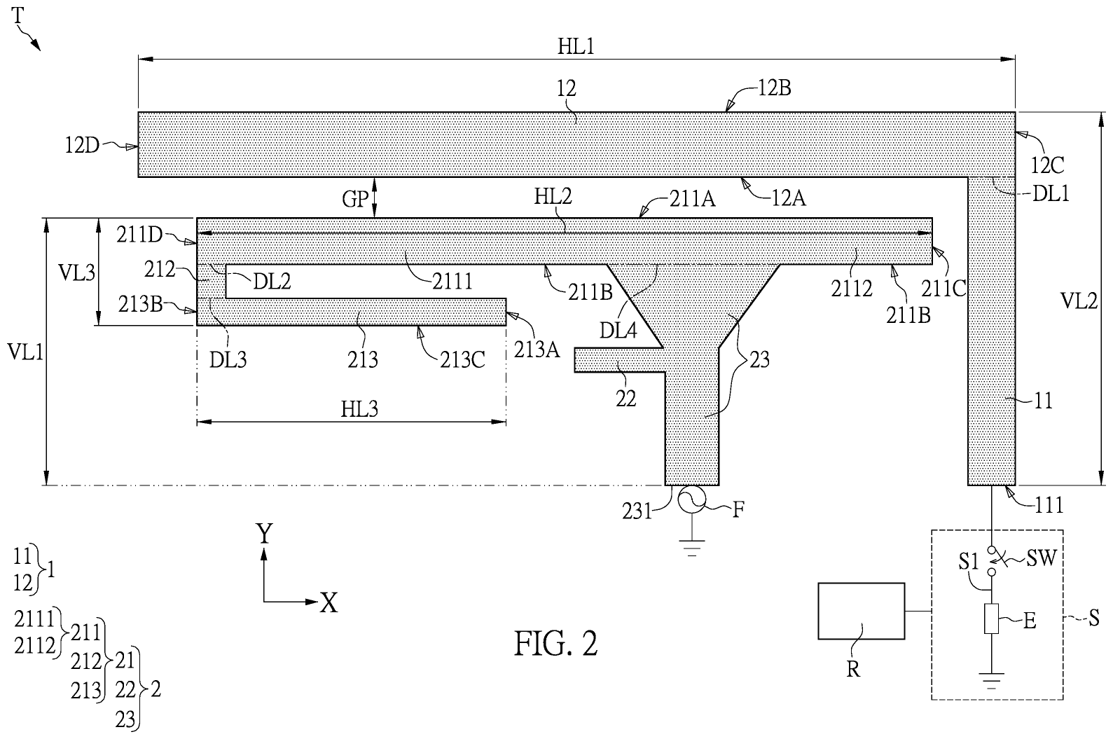

Referring to FIG. 2, FIG. 2 is a schematic view of an antenna module according to a first embodiment of the present disclosure. The first embodiment of the present disclosure provides an antenna module T, which includes a first radiating element 1 and a second radiating element 2.

The first radiating element 1 includes a first arm 11 and a second arm 12 that are connected to each other. For example, the first arm 11 and the second arm 12 can be vertically connected, such that the first radiating element 1 forms an L-shaped structure. However, the present disclosure is not limited thereto, i.e., the first arm 11 is not limited to being perpendicular to the second arm 12. The second radiating element 2 includes a first radiating portion 21 and a feeding portion 23. The first radiating portion 21 includes a first section 211, a second section 212, and a third section 213. The feeding portion 23 is connected to the first section 211. The second section 212 is connected between the first section 211 and the third section 213. Furthermore, the first section 211 includes a first branch 2111 and a second branch 2112. The first branch 2111 extends along a negative X-axis direction relative to the feeding portion 23, and the second branch 2112 extends along a positive X-axis direction relative to the feeding portion 23. The second section 212 extends along a negative Y-axis direction relative to the first branch 2111, the second section 212 is connected between the first branch 2111 and the third section 213, and the third section 213 extends along the X-axis direction relative to the second section 212. Therefore, the first branch 2111, the second section 212, and the third section 213 jointly form a hook-shaped structure that is bent in a counterclockwise direction. The first radiating element 1 is disposed on a periphery of the second radiating element 2, and the hook-shaped structure is farther away from the first arm 11 than the second branch 2112.

Specifically, the first radiating element 1 surrounds the second radiating element 2. It should be noted that the “surrounding” referred to herein is not limited to meaning that the second radiating element 2 is completely surrounded by the first radiating element 1. For example, as shown in FIG. 2, the first radiating element 1 is disposed on right and top sides of the second radiating element 2, which also meets the condition that the first radiating element 1 surrounds the second radiating element 2.

The second radiating element 2 further includes a second radiating portion 22, and the second radiating portion 22 is connected to the feeding portion 23. The electronic device D further includes a feeding element F that is electrically connected to the feeding portion 23. The second radiating portion 22 is more adjacent to the feeding element F than the first radiating portion 21. In the first embodiment, the second radiating portion 22 extends along the negative X-axis direction. However, the present disclosure is not limited thereto.

The feeding element F is used to feed a signal. The feeding element F is connected a feeding end 231 of the feeding portion 23. Specifically, one end of the feeding portion 23 (i.e., the feeding end 231) is connected to the feeding element F, and another end of the feeding portion 23 is connected between the first branch 2111 and the second branch 2112, and a width of the feeding portion 23 is increased from a positon connecting the second radiating portion 22 to a position connecting the first section 211 (along a positive Y-axis direction).

The first section 211 and the second section 212 are separated from each other by a minimum gap GP. Preferably, the minimum gap GP is smaller than or equal to 10 mm. In FIG. 2, a distance between the first branch 2111 and the second arm 12 is equal to a distance between the second branch 2112 and the second arm 12. However, the present disclosure is not limited thereto, i.e., the distances between the first section 211 and the second arm 12 are not limited to being equal. That is, the distance between the first branch 2111 and the second arm 12 can be unequal to the distance between the second branch 2112 and the second arm 12. Through the design of the minimum gap GP being smaller than or equal to 10 mm, the radiation energy of the antenna module T in the low frequency range can be enhanced.

As shown in FIG. 2, the first section 211 has a first long side 211A and a second long side 211B that are opposite to each other, and a third short side 211C and a fourth short side 211D that are opposite to each other. The second arm 12 has a first short side 12C and a second short side 12D that are opposite to each other, and a third long side 12A and a fourth long side 12B that are opposite to each other. An area of the second arm 12 is greater than an area of the first section 211. Preferably, the area of the second arm 12 is at least 1.25 times greater than the area of the first section 211. The area of the second arm 12 is the area surrounded by the first short side 12C, the second short side 12D, the third long side 12A, the fourth long side 12B and a dotted line DL1. The dotted line DL1 is a boundary line between the first arm 11 and the second arm 12. The area of the first section 211 is the area surrounded by the first long side 211A, the second long side 211B, the third short side 211C, the fourth short side 211D and dotted lines DL2 and DL4. The dotted line DL2 is a boundary line between the first section 211 and the second section 212, and the dotted line DL4 is a boundary line between the feeding portion 23 and the first section 211. Through the design of the area of the second arm 12 being at least 1.25 times greater than the area of the first section 211, the bandwidths of overall operating frequency bands of the antenna module T can be increased.

In the first section 211, the first long side 211A is more adjacent to the second arm 12 than the second long side 211B, and the feeding portion 23 is connected to the second long side 211B. The feeding end 231 and the first long side 211A have a first longitudinal length VL1 therebetween. In the second arm 12, the fourth long side 12B is farther away from the second radiating element 2 than the third long side 12A. The first arm 11 has a short side 111, and the short side 111 and the fourth long side 12B have a second longitudinal length VL2 therebetween. The second longitudinal length VL2 is greater than or equal to the first longitudinal length VL1.

Moreover, in the second arm 12, the first short side 12C is connected to the first arm 11, and the first short side 12C and the second short side 12D have a first transverse length HL1 therebetween. In the first section 211, the fourth short side 211D is connected to the second section 212, and the third short side 211C and the fourth short side 211D have a second transverse length HL2 therebetween. The first transverse length HL1 is greater than or equal to the second transverse length HL2. A dotted line DL3 is used as a boundary line between the second section 212 and the third section 213. The third section 213 has a fifth short side 213A, a sixth short side 213B, and a fifth long side 213C. The fifth short side 213A and the sixth short side 213B are opposite to each other. The sixth short side 213B is connected to the second section 212, and the fifth long side 213C is connected between the fifth short side 213A and the sixth short side 213B. The fifth short side 213A and the sixth short side 213B have a third transverse length HL3 therebetween. The third transverse length HL3 is smaller than the second transverse length HL2. In addition, the first long side 211A of the first section 211 and the fifth long side 213C of the third section 213 have a third longitudinal length VL3 therebetween. The third longitudinal length VL3 is smaller than the first longitudinal length VL1.

Therefore, the impedance matching of the antenna module T can be improved through one of the above structural designs (i.e., the second longitudinal length VL2 is greater than or equal to the first longitudinal length VL1, or the first transverse length HL1 is greater than or equal to the second transverse length HL2, or the third transverse length HL3 is smaller than the second transverse length HL2, or the third longitudinal length VL3 is smaller than the first longitudinal length VL1) of the first radiating element 1 and the second radiating element 2.

Reference is further made to FIGS. 1 and 2. The electronic device further includes a switching circuit S that is electrically connected to the first radiating element 1. Specifically, the switching circuit S is electrically connected to the short side 111 of the first arm 11. The switching circuit S includes a path S1. The path S1 includes a switch SW and a passive element E. The switching circuit S can be switched to different modes through different switching states of the switch SW, and equivalent impedances produced by the switching circuit S in different modes are different from each other. However, the switch SW in FIG. 2 is merely an example, and is not meant to limit the scope of the present disclosure. A quantity of the path S1 is not limited in the present disclosure. For example, the switching circuit S can include multiple paths, and different modes can be combinations of different paths. In addition, the passive element E can be an inductor, a capacitor or a resistor, and the present disclosure is not limited thereto. In the electronic device D, the operating frequency bands, the impedance matching, and the radiation efficiency of the antenna module T can be adjusted by the configuration of the passive element E.

The electronic device D further includes a control circuit R that is electrically connected to the switching circuit S, and the control circuit R controls the switching circuit S to switch to one of the plurality of modes and adjust the operating frequency band of the antenna module T. For example, in the present disclosure, the second radiating element 2 is a monopole antenna, and the type of the first radiating element 1 depends on the state of the switch SW in the switching circuit S.

In FIG. 2, in response to the switching circuit S being switched to a first mode, the switch SW is in a conducting state, and the signal is grounded through the path S1. Therefore, the signal is fed into the feeding portion 23 of the second radiating element 2 through the feeding element F, and is coupled to the first radiating element 1 through the second radiating element 2 to generate an operating frequency band from 617 MHz to 960 MHz. It should be noted that the hook-shaped structure (the first branch 2111, the second section 212, and the third section 213) extends along the negative X-axis direction. The direction of the current (i.e., the signal) can be adjusted by having the hook-shaped structure be farther away from the first arm 11 than the second branch 2112, such that the current passes through the feeding portion 23, the hook-shaped structure, the second arm 12, and the first arm 11 in sequence and is grounded, and the electromagnetic waves generated by the antenna module T can form constructive interference or reduce the formation of destructive interference, thereby increasing radiation energy and improving radiation efficiency.

In response to the switching circuit S being switched to a second mode, the switch SW is in a non-conducting state. The first radiating element 1 is not grounded, that is, the first radiating element 1 is a floating arm. Therefore, the signal is fed into the feeding portion 23 of the second radiating element 2 through the feeding element F, and is coupled to the first radiating element 1 through the second radiating element 2 to improve impedance matching and enhance the antenna radiation efficiency.

In addition, the feeding element F is used to feed the signal to excite the second radiating element 2 and generate a plurality of different operating frequency bands. For example, the signal passes through the feeding part 23, the first branch 2111, the second section 212 and the third section 213 to generate operating frequency bands from 800 MHz to 960 MHz and 2,400 MHz to 2,690 MHz. The signal passes through the feeding portion 23 and the second branch 2112 to generate an operating frequency band from 1420 MHz to 2,690 MHz. The signal passes through a part of the feeding portion 23 and the second radiating portion 22 to generate an operating frequency band from 3,000 MHz to 6,000 MHz.

### Second Embodiment

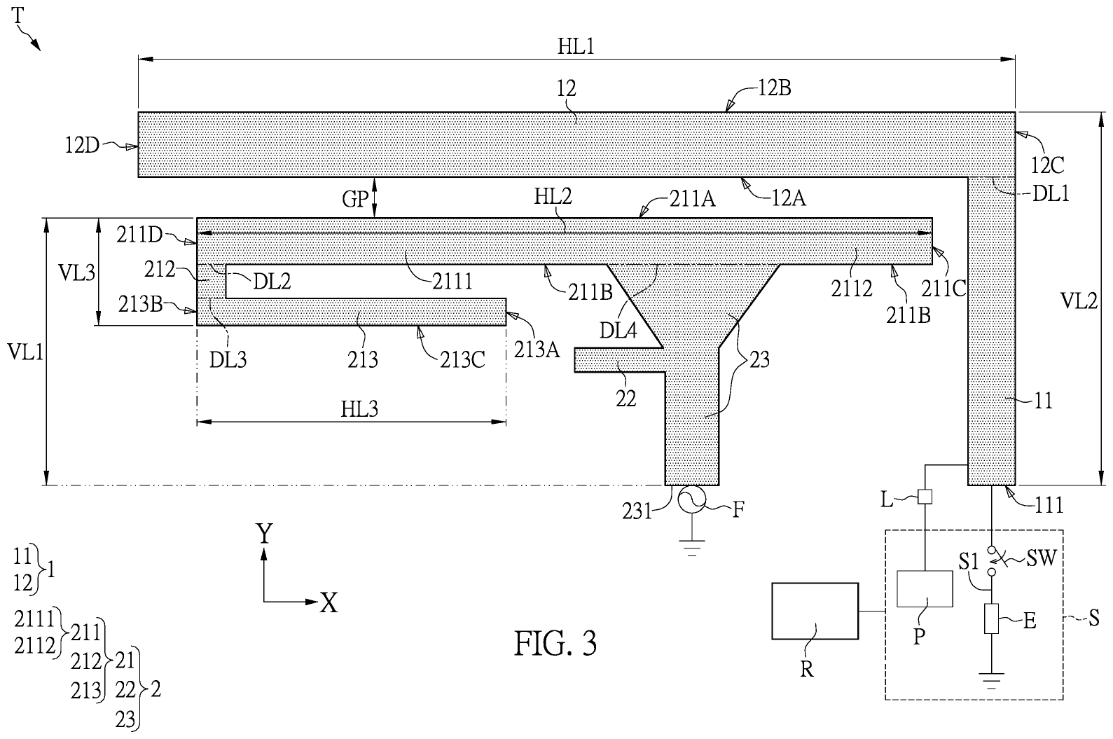

Referring to FIG. 3, FIG. 3 is a schematic view of an antenna module according to a second embodiment of the present disclosure. The antenna module T of the second embodiment has a structure similar to that of the first embodiment, and the similarities therebetween will not be reiterated herein. The main difference between the second embodiment and the first embodiment is as follows: in the second embodiment, the antenna module T further includes a proximity sensing circuit P that is electrically connected to the first radiating element 1. The proximity sensing circuit P can be, for example, a capacitance sensing circuit, and the proximity sensing circuit P is further electrically connected to a mainboard (not shown in the figures).

The first radiating element 1 of the antenna module T can be used as a sensing electrode (i.e., a sensor pad) through the configuration of the proximity sensing circuit P, such that the proximity sensing circuit P can measure a distance between an object (such as the leg or other body parts of a user) and the antenna module T. In addition, a sensing signal detected by the proximity sensing circuit P through the sensing electrode will be sent back to the mainboard. In this way, the electronic device D can be used to sense whether or not the human body is in close proximity of the antenna module T, and the radiation power transmitted by an RF module (not shown in the figures) on the mainboard to the antenna can be adjusted, thereby preventing a specific absorption rate (SAR) at which electromagnetic wave energy is absorbed per unit mass by an organism from being too high. Moreover, as shown in FIG. 3, the proximity sensing circuit P can be integrated into the switching circuit S. The proximity sensing circuit P can also be independently disposed outside the switching circuit S, such as being disposed adjacent to the antenna module T. Alternatively, the proximity sensing circuit P can be independently disposed on the mainboard.

Moreover, the antenna module T further includes an inductor L, and the inductor L is connected in series between the proximity sensing circuit P and the first arm 11 of the first radiating element 1. The inductor L can serve as an RF choke to prevent the RF signal generated by the feeding element F from flowing into the proximity sensing circuit P.

### Beneficial Effects of the Embodiments

In the electronic device D and the antenna module T provided by the present disclosure, by virtue of “the first branch 2111, the second section 212, and the third section 213 jointly forming a hook-shaped structure, the first radiating element 1 being disposed on a periphery of the second radiating element 2, and the hook-shaped structure being farther away from the first arm 11 than the second branch 2112,” the characteristics of the antenna can be optimized to meet more stringent antenna specifications.

Furthermore, the direction of the current (i.e., the signal) can be adjusted by having the hook-shaped structure be farther away from the first arm 11 than the second branch 2112, such that the current passes through the feeding portion 23, the hook-shaped structure, the second arm 12, and the first arm 11 in sequence and is grounded, and the electromagnetic waves generated by the antenna module T can form constructive interference or reduce the formation of destructive interference, thereby increasing radiation energy and improving radiation efficiency.

In addition, the radiation energy of the antenna module T in the low frequency range can be enhanced through the design of the minimum gap GP being smaller than or equal to 10 mm. The bandwidths of overall operating frequency bands of the antenna module T can be increased through the design of the area of the second arm 12 being at least 1.25 times greater than the area of the first section 211. The impedance matching of the antenna module T can be improved through one of the above structural designs (i.e., the second longitudinal length VL2 is greater than or equal to the first longitudinal length VL1, or the first transverse length HL1 is greater than or equal to the second transverse length HL2, or the third transverse length HL3 is smaller than the second transverse length HL2, or the third longitudinal length VL3 is smaller than the first longitudinal length VL1) of the first radiating element 1 and the second radiating element 2.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An electronic device, comprising:
a housing;
an antenna module disposed in the housing, wherein the antenna module includes:
a first radiating element including a first arm and a second arm that is connected to the first arm; and
a second radiating element including a first radiating portion and a feeding portion, wherein the first radiating portion includes a first section, a second section, and a third section, the feeding portion is connected to the first section, the first section includes a first branch and a second branch, and the second section is connected between the first branch and the third section; wherein the first branch, the second section, and the third section jointly form a hook-shaped structure, the first radiating element is disposed on a periphery of the second radiating element, and the hook-shaped structure is farther away from the first arm than the second branch; and
a feeding element electrically connected to the feeding portion.

2. The electronic device according to claim 1, wherein the second radiating element further includes a second radiating portion, wherein the second radiating portion is connected to the feeding portion, and the second radiating portion is more adjacent to the feeding portion than the first radiating portion.

3. The electronic device according to claim 1, wherein the first section and the second arm are separated from each other by a minimum gap, and the minimum gap is smaller than or equal to 10 mm.

4. The electronic device according to claim 1, wherein an area of the second arm is at least 1.25 times greater than an area of the first section.

5. The electronic device according to claim 1, wherein the first section has a first long side and a second long side that are opposite to each other, the first long side is more adjacent to the second arm than the second long side, the feeding portion is connected to the second long side, the feeding portion has a feeding end that is electrically connected to the feeding element, and the feeding end and the first long side have a first longitudinal length therebetween; wherein the first arm has a short side, the second arm has a third long side and a fourth long side that are opposite to each other, the fourth long side is farther away from the second radiating element than the third long side, and the short side and the fourth long side have a second longitudinal length therebetween; wherein the second longitudinal length is greater than or equal to the first longitudinal length.

6. The electronic device according to claim 5, wherein the second arm further has a first short side and a second short side that are opposite to each other, the first short side is connected to the first arm, and the first short side and the second short side have a first transverse length therebetween; wherein the first section further has a third short side and a fourth short side that are opposite to each other, the fourth short side is connected to the second section, and the third short side and the fourth short side have a second transverse length therebetween; wherein the first transverse length is greater than or equal to the second transverse length.

7. The electronic device according to claim 6, wherein the third section has a fifth short side and a sixth short side that are opposite to each other, the sixth short side is connected to the second section, the fifth short side and the sixth short side have a third transverse length therebetween, and the third transverse length is smaller than the second transverse length.

8. The electronic device according to claim 7, wherein the third section further has a fifth long side that is connected between the fifth short side and the sixth short side, the first long side of the first section and the fifth long side of the third section have a third longitudinal length therebetween, and the third longitudinal length is smaller than the first longitudinal length.

9. The electronic device according to claim 1, further comprising a switching circuit and a proximity sensing circuit that are electrically connected to the first radiating element, wherein the switching circuit includes a path, and the path includes a switch and a passive element; wherein the switching circuit is switched to different modes through different switching states of the switch, and equivalent impedances produced by the switching circuit in different modes are different from each other.

10. An antenna module, comprising:
a first radiating element including a first arm and a second arm that is connected to the first arm; and
a second radiating element including a first radiating portion and a feeding portion, wherein the first radiating portion includes a first section, a second section, and a third section, the feeding portion is connected to the first section and is electrically connected to a feeding element, the first section includes a first branch and a second branch, and the second section is connected between the first branch and the third section; wherein the first branch, the second section, and the third section jointly form a hook-shaped structure, the first radiating element is disposed on a periphery of the second radiating element, and the hook-shaped structure is farther away from the first arm than the second branch.

11. The antenna module according to claim 10, wherein the second radiating element further includes a second radiating portion, wherein the second radiating portion is connected to the feeding portion, and the second radiating portion is more adjacent to the feeding portion than the first radiating portion.

12. The antenna module according to claim 10, wherein the first section and the second arm are separated from each other by a minimum gap, and the minimum gap is smaller than or equal to 10 mm.

13. The antenna module according to claim 10, wherein an area of the second arm is at least 1.25 times greater than an area of the first section.

14. The antenna module according to claim 10, wherein the first section has a first long side and a second long side that are opposite to each other, the first long side is more adjacent to the second arm than the second long side, the feeding portion is connected to the second long side, the feeding portion has a feeding end that is electrically connected to the feeding element, and the feeding end and the first long side have a first longitudinal length therebetween; wherein the first arm has a short side, the second arm has a third long side and a fourth long side that are opposite to each other, the fourth long side is farther away from the second radiating element than the third long side, and the short side and the fourth long side have a second longitudinal length therebetween; wherein the second longitudinal length is greater than or equal to the first longitudinal length.

15. The antenna module according to claim 14, wherein the second arm further has a first short side and a second short side that are opposite to each other, the first short side is connected to the first arm, and the first short side and the second short side have a first transverse length therebetween; wherein the first section further has a third short side and a fourth short side that are opposite to each other, the fourth short side is connected to the second section, and the third short side and the fourth short side have a second transverse length therebetween; wherein the first transverse length is greater than or equal to the second transverse length.

16. The antenna module according to claim 15, wherein the third section has a fifth short side and a sixth short side that are opposite to each other, the sixth short side is connected to the second section, the fifth short side and the sixth short side have a third transverse length therebetween, and the third transverse length is smaller than the second transverse length.

17. The antenna module according to claim 16, wherein the third section further has a fifth long side that is connected between the fifth short side and the sixth short side, the first long side of the first section and the fifth long side of the third section have a third longitudinal length therebetween, and the third longitudinal length is smaller than the first longitudinal length.
